(19) United States
(12) Patent Application Publication
(10) Pub. No.: US 2022/0063206 A1
(43) Pub. Date: Mar. 3, 2022

(54) Storage bag and an apparatus and method for making the storage bag

(71) Applicants: Roger Thomas Kurtin, Houston, TX (US); Diana Ya-Wen Wang, Houston, TX (US)

(72) Inventors: Roger Thomas Kurtin, Houston, TX (US); Diana Ya-Wen Wang, Houston, TX (US)

(21) Appl. No.: 17/009,344

(22) Filed: Sep. 1, 2020

(51) Int. Cl. B29C 65/20; B65D 33/16; B65D 33/28; B29C 65/00

(52) U.S. Cl. CPC B29C 65/20; B65D 33/1633; B29L 2031/7129; B29C 66/434; B65D 33/28

(57) ABSTRACT

A storage bag comprising a floor, the floor having four corners and edges, the four corners defining a planar surface; a pair of opposing triangular interstitial regions, each triangular interstitial region having a vertex, two sides, and a base, the base of the triangle co-linear with one edge of the floor; a gusset, the gusset bisecting the floor region and both opposing interstitial regions, the gusset co-linear with the vertex of both of triangular interstitial regions; a pair of opposing body regions, the lower edge of each opposing body regions co-linear with two corners of the floor region; and, an opening, the corners of the opening forming an imaginary plane, wherein the planar surface formed by the corners of the floor region and the imaginary plane formed by the opening of the body region are in parallel planes after the storage bag is opened for use.

### CROSS-REFERENCE TO RELATED APPLICATIONS

None

### STATEMENT REGARDING FEDERALLY SPONSORED RESEARCH

Not Applicable.

### TECHNICAL FIELD OF THE INVENTION

The technical field of this disclosure relates to storage bags and more particularly to reclosable storage bags that are used in conjunction with a food storage bin. The food storage bin is also referred to in the industry as a food storage pan.

### BACKGROUND OF THE INVENTION

Typically, food preparers find it useful to have ready access to ingredients that are frequently used in preparing items. For example, a pizza parlor may find it advantageous to have pizza toppings readily available to a chef preparing a pizza. Because of the large number of potential combinations of toppings and the high order volume, it would be inefficient for the chef to retrieve each ingredient from a refrigerator for each pizza that she prepares. Instead, it has been found to be more efficient to temporarily store each topping in its own segregated pan or bin. In some cases, this also allows pre-use preparation of the ingredient. For example, tomatoes or pepperoni could be sliced or cut before being placed in the food storage bin. This would allow the chef to have these ingredients readily available. If the chef were required to cut, slice, trim or otherwise prepare an ingredient before adding it to a recipe or food being prepared, this would slow the process of preparing the completed food. For example, when the ingredient is required for a pizza topping, the chef can remove the desired ingredient and use it on the pizza. Of course, at the end of the food service, each bin will likely contain some remaining amount of each ingredient. Currently, rather than discarding the ingredient, the chef will transfer the ingredient to a plastic or paper storage bag and then place the storage bag into a cooler or refrigerator for later use. Because chefs may require access to many ingredients, this can require a significant amount of time to transfer a substantial number of ingredients from the bin to the storage bag and then place the storage bag into the cooler. During the transfer, the ingredient may spill and become unusable because of contact with the floor or other non-food preparation surface. Therefore, the present use of bins and storage bags is inefficient, both from a time inefficiency and a food waste perspective. If the food storage bin is moved into a cooler, without first transferring the ingredient into the storage bag, the ingredient will be exposed directly to the cool air inside the cooler. This cooler air may precipitate and encourage untoward and unsightly cosmetic and taste changes to the ingredient. For example, an ingredient, such as a fruit, may lose its texture or discolor after storage in the cooler. A good example of this is the flesh of a sliced apple that is stored in a refrigerator overnight will turn brown. This does not affect the edibleness of the sliced apple, but it severely degrades the cosmetic appearance of the sliced apple and renders it potentially undesirable for consumption. Any of these instances are undesirable and would likely require that the ingredient be discarded. This would represent a loss because of the cost of the discarded ingredient is not recoverable and would require that the discarded ingredient be replaced, i.e. purchasing additional fresh apples and paying a food preparer to slice or cut them for use as an ingredient. Both of these activities represent a loss to the food preparing facility because of the cost of replacing the unusable food and the additional labor required to prepare (cut, slice, etc. . . . ) the ingredient.

Currently, numerous plastic and paper storage bags exist that could be used in conjunction with the storage bins. However, the current bags don't readily fit within the current storage bins and also interfere with the removal of the ingredient within the bag. In addition, there are problems with closing the current bags for storage.

Storage bags, whether plastic or paper, are typically manufactured in large quantities at a plant and then shipped in boxes to a distributor. In turn, the distributor then sells the boxes of storage bags to customers that use them in the preparation of food for sale to customers. Because of the large volume of bags used in the food preparation industry, a large number of storage bags are shipped together stacked flat in a shipping box. In many cases, an entire shipping container will be shipped filled with shipping boxes containing storage bags.

Paper bags typically have a flat bottom surface. However, paper can be less useful than a plastic bag because it can leak and, if exposed to grease or other liquids, the paper bags weaken and fall apart. Also, paper bags tend to be thicker and weigh more than plastic bags. This additional volume and weight increase shipping costs relative to a storage bag made from plastic. While papers bags have a flat bottom that fits more readily in the storage bin, current plastic storage bags, don't have a flat bottom and do not readily fit into current storage bins. Similarly, current plastic storage bags don't conform well to the current food storage bins or pans. This makes removal of ingredients from current bags more difficult than is desireable. This also makes removal of the the current plastic storage bags from storage bins more difficult than is desirable. As such, there is a need for a reclosable storage bag that can address these problems and which can also be readily manufactured and shipped from the manufacturing site to food preparation locations, such as restaurants, buffets, pizza parlors and the like.

For at least these reasons, it is preferable to employ reclosable storage bags that are address these problems.

### BACKGROUND

FIG. 1A illustrates a typical prior art food storage pan or bin B_{S}. Examples of such prior art food storage pans or bins B_{S} include, but are not limited to, a Thunder Group STPA8166 or a Vollrath Super Pan SN 631-1. The Vollrath Super Pan is believed to be the subject of U.S. Pat. No. 6,557,720. The Thunder Group bin may be referred to broadly as a small bin B_{S}, and is illustrated in FIGS. 1A-C, has dimensions of six inches wide, seven inches long, and six inches deep (In metric units, these are: 15.24 centimeters wide, 17.78 centimeters long, and 15.24 centimeters deep). The Vollrath Super Pan may be referred to broadly as a large bin B_{L}, illustrated in FIGS. 2A-C, and has dimensions of 12.75 inches wide, seven inches long, and six inches deep. (In metric units, these are: 32.385 centimeters wide, 17.78 centimeters long, and 15.24 centimeters deep.) As illustrated by comparing FIGS. 1A-C and 2A-C, alternative embodiments of the prior art storage bin B_{S} or B_{L} can be longer, wider, narrower, shorter, shallower, or deeper depending on the amount of the ingredient that will be kept in the prior art storage bin Bₛ or B_{L}. Prior art bins B are also steam table food pans or bins. While typically made of stainless steel, bins B may be made of any type of metal or plastic. Alternatively, bins B_{S} and B_{L} are “nestable” in a well. This allows the chef or kitchen personnel to select ingredients as needed. For example, a table might have four wells that hold four prior art storage bins B_{S,L}. Preferably, each bin B_{S,L} will contain a different ingredient. For example, in a pizza kitchen, the four ingredients in each of the wells might be salami, Italian sausage, mushrooms, and mozzarella cheese. Of course, if one ingredient is used very frequently, multiple bins B_{S,L} could contain the same ingredient. However, as discussed above, when it is time to return the ingredients to storage, because the business is closing or different food products are being prepared, the chef will have to remove the food from the bins, and place the ingredient into a container and then place the container into an appropriate storage location. Each of these steps takes time and effort. In addition to the effort required to remove and store ingredients, when the ingredients are going to be used for future meals, each ingredient will have to be placed in its respective bin, and the bin placed in the proper location for use by the chef or food preparer. Each additional step requiring time and effort in a fast paced kitchen environment.

### SUMMARY OF THE INVENTION

A storage bag comprising a floor, the floor having four corners and edges, the four corners defining a planar surface; a pair of opposing triangular interstitial regions, each triangular interstitial region having a vertex, two sides, and a base, the base of the triangle co-linear with one edge of the floor; a gusset, the gusset bisecting the floor region and both opposing interstitial regions, the gusset co-linear with the vertex of both of triangular interstitial regions; a pair of opposing body regions, the lower edge of each opposing body region co-linear with two corners of the floor region; and, an opening, the corners of the opening forming an imaginary plane, wherein the planar surface formed by the corners of the floor region and the imaginary plane formed by the opening of the body region are in parallel planes after the storage bag is opened for use.

These and other embodiments will be more fully appreciated from the description below.

### BRIEF DESCRIPTION OF THE DRAWINGS

FIG. 1A illustrates a perspective view of a typical prior art small food storage pan or bin.

FIG. 1B illustrates a top view of a typical prior art small food storage pan or bin illustrated in FIG. 1A.

FIG. 1C illustrates a side view of the typical prior art small food storage pan or bin illustrated in FIGS. 1A and 1B. The opposite side view and front rear views are mirror images.

FIG. 2A illustrates a perspective view of a typical prior art large food storage pan or bin.

FIG. 2B illustrates a top view of a typical prior art large food storage pan or bin illustrated in FIG. 2A.

FIG. 2C illustrates a side view of the typical prior art large food storage pan or bin illustrated in FIGS. 2A and 2B. The opposite side view and front and rear views are mirror images.

FIG. 3A illustrates a perspective view of an embodiment of a storage bag.

FIG. 3B illustrates a top view of the storage bag.

FIG. 3C illustrates a right view of the storage bag. The left side view is a mirror image.

FIG. 3D illustrates a front view of the storage bag. The rear side view is a mirror image.

FIG. 3E illustrates a bottom view of the storage bag.

FIG. 4A illustrates a perspective view of a larger embodiment of the storage bag.

FIG. 4B illustrates an top view of the larger embodiment of the storage bag.

FIG. 4C illustrates a right side view of the larger embodiment of the storage bag. The left side view is a mirror image.

FIG. 4D illustrates a front view of the larger embodiment of the storage bag. The rear view is a mirror image.

FIG. 4E illustrates a bottom view of the larger embodiment of the storage bag.

FIG. 5A illustrates a perspective view of an alternative embodiment of the storage bag.

FIG. 5B illustrates a top view of the alternative embodiment of the storage bag.

FIG. 5C illustrates a right side view of the alternative embodiment of the storage bag.

FIG. 5D illustrates a bottom view of the alternative embodiment of the storage bag.

FIG. 5E illustrates a right view of the alternative embodiment of the storage bag.

FIG. 5F illustrates a left side view of the alternative embodiment of the storage bag.

FIG. 5G illustrates a rear view of the alternative embodiment of the storage bag.

FIG. 6A illustrates a perspective view of an alternative embodiment of the larger embodiment of the storage bag.

FIG. 6B illustrates a top view of the alternative embodiment of the larger embodiment of the storage bag.

FIG. 6C illustrates a front view of the alternative embodiment of the larger storage bag.

FIG. 6D illustrates a bottom view of the alternative embodiment of the larger storage bag.

FIG. 6E illustrates a right side view of the alternative embodiment of the larger storage bag.

FIG. 6F illustrates a rear view of the alternative embodiment of the larger storage bag.

FIG. 6G illustrates a left side view of the alternative embodiment of the larger storage bag.

FIG. 7A illustrates a schematic view of a preferred machine for manufacturing the storage bags.

FIG. 7B illustrates a schematic view of an alternative embodiment of the machine for manufacturing the storage bags.

FIG. 8A-8I illustrates a manufacturing method, also referred to as a process, of manufacturing the storage bag.

FIG. 8A illustrates a perspective view of the side-folded plastic film used to manufacture the storage bag.

FIG. 8B illustrates a perspective view of the manufacturing process of the storage bag after opposing flaps have been formed in the plastic film used to manufacture the storage bag.

FIG. 8C illustrates a perspective view of the manufacturing process of the storage bag after a gusset has been formed in the plastic material used to manufacture the storage bag.

FIG. 8D illustrates a perspective view of the manufacturing process of the storage bag after a hole has been punched in the in the plastic film used to manufacture the storage bag.

FIG. 8E illustrates a perspective view of the manufacturing process of the storage bag after a drawstring has been placed in channel in the in the plastic film used to manufacture the storage bag.

FIG. 8F illustrates a perspective view of the manufacturing process of the storage bag after a channel containing the drawstring in in the plastic film used to manufacture the storage bag has been sealed along the bottom edge of the channel.

FIG. 8G illustrates a perspective view of the manufacturing process of the storage bag after edges have been sealed.

FIG. 8H illustrates a perspective view of the manufacturing process of the storage bag after a portion of the material is removed.

FIG. 8I illustrates a perspective view of the unopened storage bag produced by the manufacturing process.

FIG. 9A illustrates a front view of an unopened storage bag produced by the manufacturing process for the storage bag. FIG. 9A further illustrates the preferred dimensions of the smaller storage bag.

FIG. 9B illustrates a right side view of the storage bag after the bag has been opened. The left side view is a mirror image. FIG. 9B is a slightly closer view of FIG. 3C, above. FIG. 9B further illustrates the preferred dimensions of the smaller storage bag.

FIG. 10A illustrates a front view of an unopened storage bag produced by the manufacturing process for the larger embodiment of the reclosable bag. FIG. 10A further illustrates the preferred dimensions of the larger storage bag.

FIG. 10B illustrates a right side view of the storage bag. The left side view is a mirror image. FIG. 10B is a slightly closer view of FIG. 4C, above. FIG. 10B further illustrates the preferred dimensions of the larger storage bag.

FIG. 11A illustrates a perspective view of an alternative slide lock closure for the storage bag.

FIG. 11B illustrates a perspective view of an alternative press-to-close closure for the storage bag.

FIG. 12A illustrates a perspective view of the embodiment illustrated in FIGS. 3A-3E in conjunction with the typical prior art small food storage pan or bin illustrated in FIGS. 1A-1C.

FIG. 12B illustrates a perspective view of the embodiment illustrated in FIGS. 4A-4E in conjunction with the typical prior art large food storage pan or bin illustrated in FIGS. 2A-2C.

FIG. 13 illustrates a perspective view of the storage bag illustrated in FIG. 3A and further illustrates imaginary planar surfaces of the mouth of the storage bag and the corners of the floor region of the storage bag. FIG. 13 further illustrates that the two imaginary planes are substantially parallel.

FIG. 14 illustrates a perspective view of the larger embodiment of the storage bag illustrated in FIG. 4A and further illustrates imaginary planar surfaces of the mouth of the larger embodiment of the storage bag and the corners of the floor region of the storage bag. FIG. 14 further illustrates that the two imaginary planes are substantially parallel.

### DESCRIPTION OF THE PREFERRED EMBODIMENTS

Corresponding reference numbers indicate corresponding parts throughout the several views of the drawings and specification.

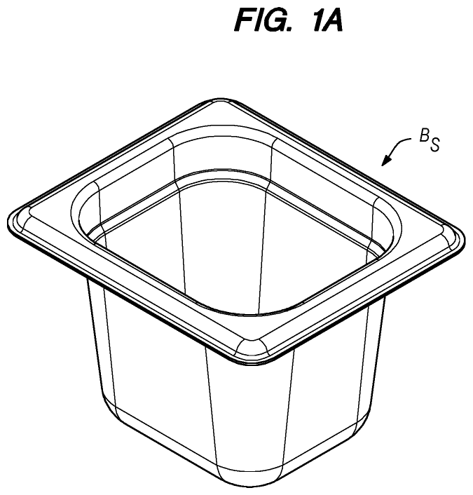

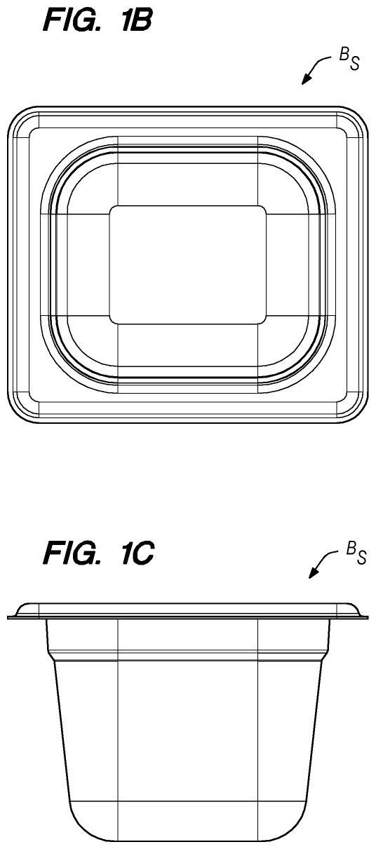

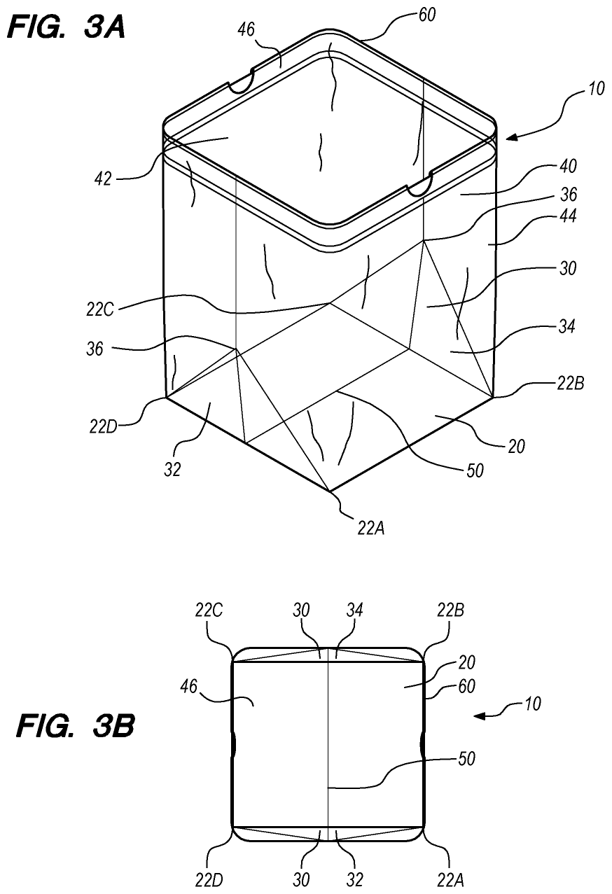

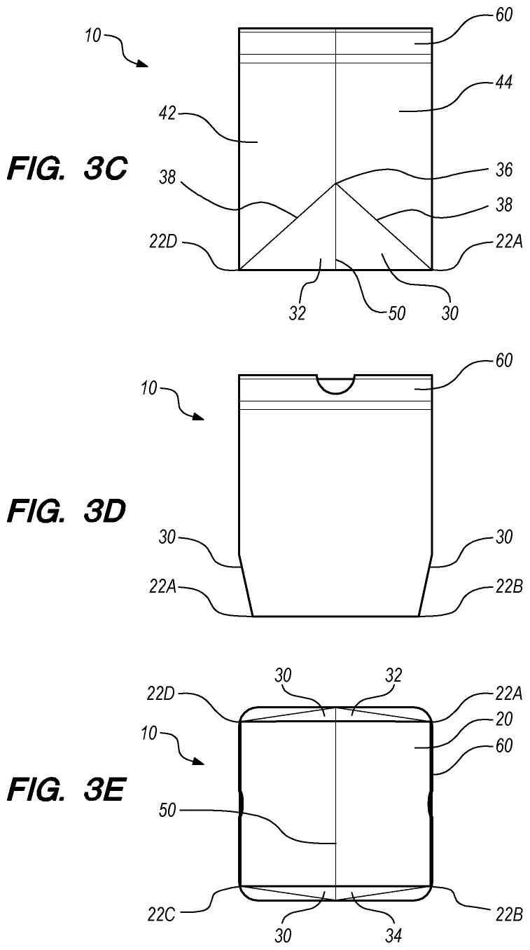

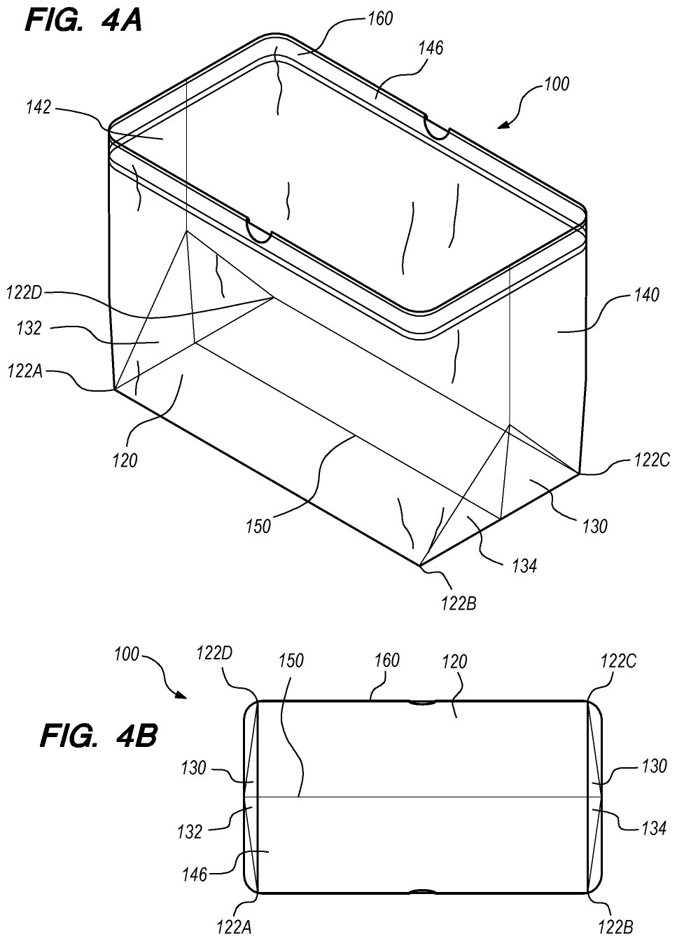

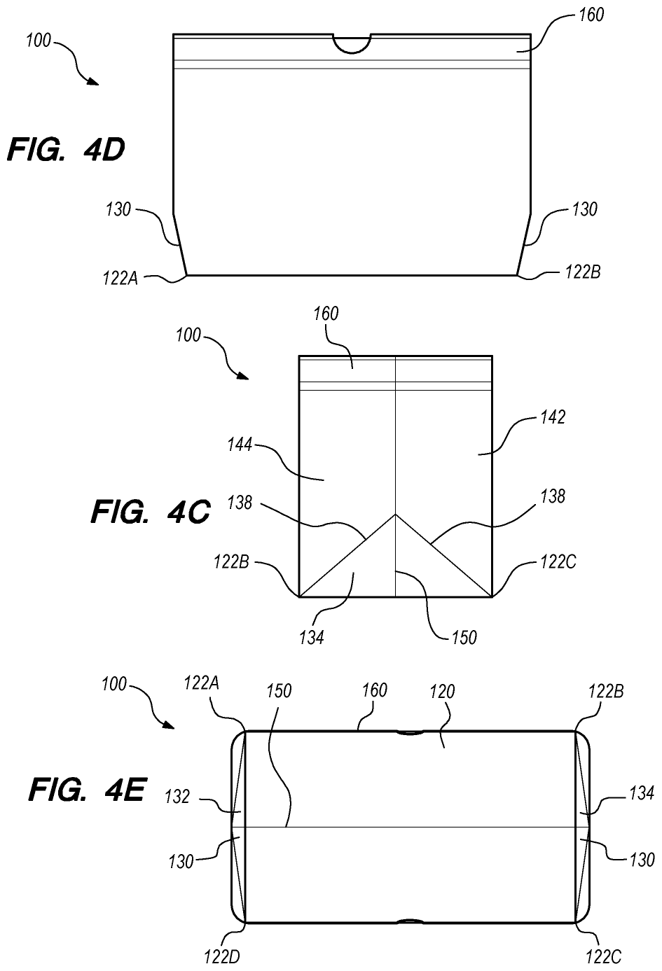

FIG. 3A illustrates an embodiment of a storage bag 10 in the opened position. Preferably, storage bag 10 is reclosable. Thus, storage bag 10 may be referred to as a recloseable bag 10. Reclosable bag 10 is typical used in conjunction with the small food storage pan or bin B_{S} illustrated in FIGS. 1A, 1B, and 1C. Recloseable bag 10 comprises a floor region 20, interstitial regions 30, a body region 40, and, in the preferred embodiment, a drawstring unit 60. This embodiment may generally be thought of as the “small bag” and the alternative embodiment, also illustrated at FIG. 4A-4E may be thought of as the “larger bag” or “large bag.” However, this does not mean that a dimension in the “small bag” could not be larger than a dimension of the “large bag,” or visa-versa.

FIGS. 3B and 3C illustrate recloseable bag 10. FIGS. 3B and 3C also illustrate that floor region 20 is substantially planar and the four corners that are illustrated as 22A, 22B, 22C, and 22D, are substantially in the same plane. Preferably, corners 22A, 22B, 22C, and 22D form a flat surface and are planar. As such, corners A, B, C, and D form a substantially planar surface. The length between each corner may be referred to as an edge of the floor region 20. For example, the section of the floor region 20 defined by corner 22A and corner 22B may be referred to as one of the edges of floor region 20. Correspondingly, the edge defined by corners 22B-22C, 22C-22D, and, 22D-22A may also be referred to as edges of floor region 20.

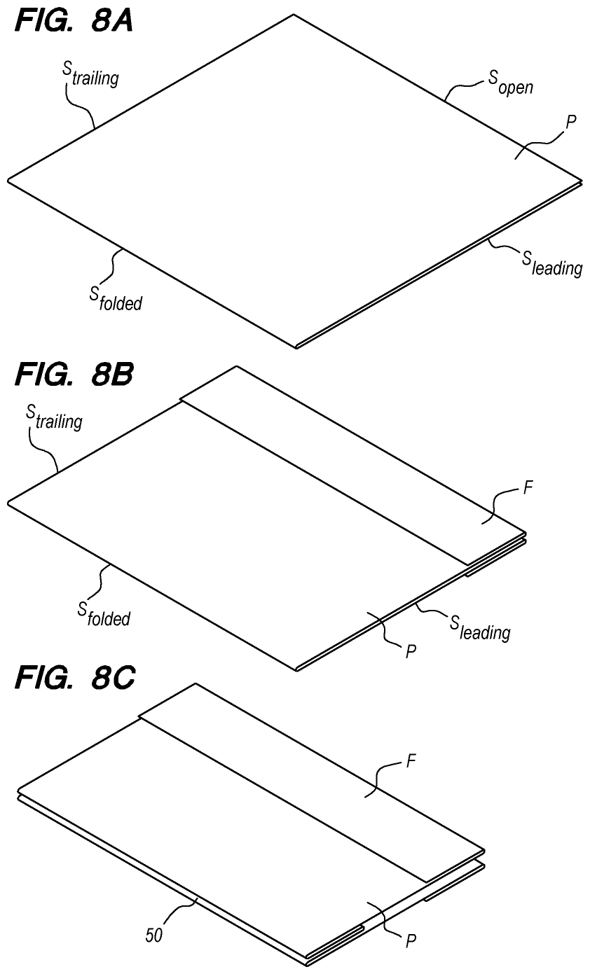

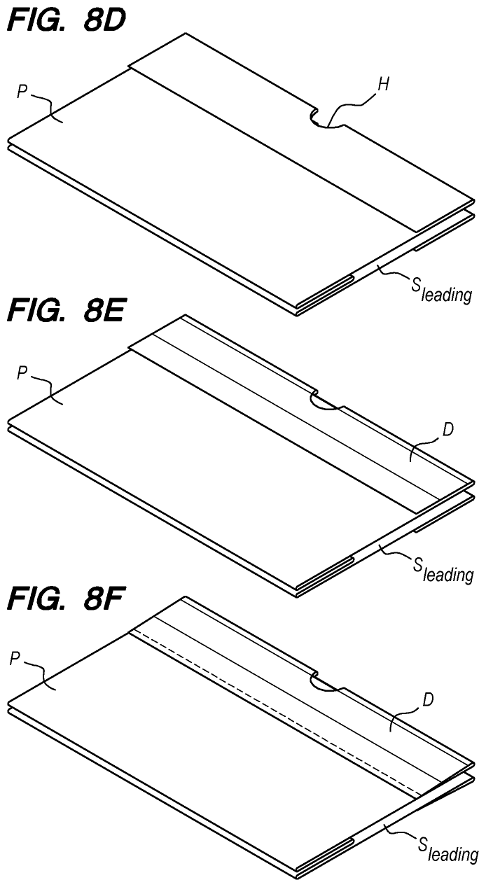

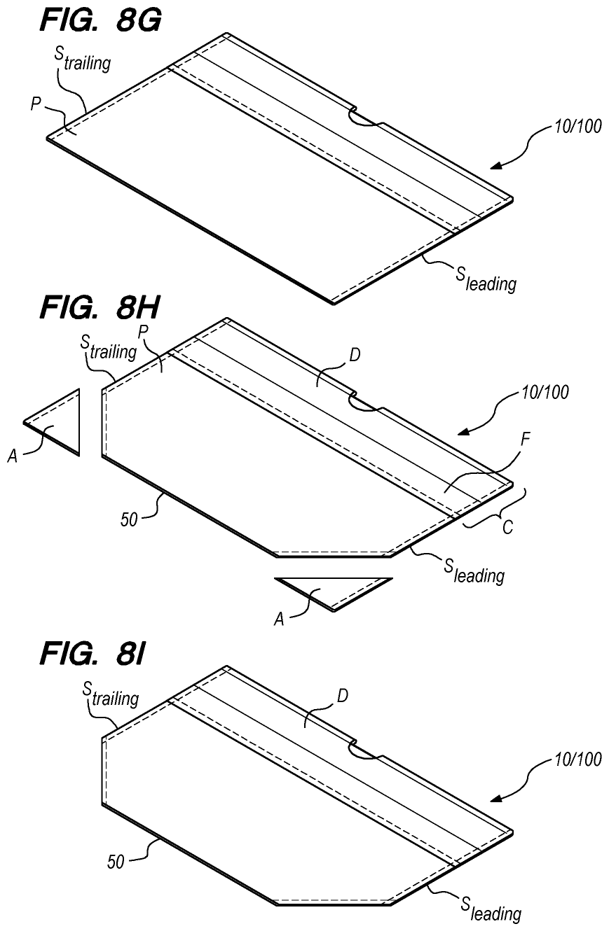

FIGS. 3A, 3B, 3C, and 3D, illustrate the recloseable bag 10. FIGS. 3A, 3B, and 3C illustrates body region 40. Body region 40 has a first side 42, a second side 44, opening 46, and, preferably, a drawstring unit 60. The formation of draw string unit 60 will be more fully described below in FIGS. 8A-8I. Opening 46 defines the mouth of recloseable bag 10 and also forms an imaginary substantially planar surface that is preferably parallel to the imaginary substantially planar surface formed by corners 22A, 22B, 22C, and 22D. Phrased differently, preferably, both the plane of the imaginary surface defined by the mouth of opening 46 and plane of the surface formed by corners 22A, 22B, 22C, and 22D are parallel to each other. FIGS. 3B and 3C illustrate drawstring unit 60. In a preferred embodiment, drawstring unit 60 allows a user to close opening 46 of recloseable bag 10. Drawstring unit 60 is optional. FIGS. 3A and 3B also illustrates interstitial region 30. Interstitial region 30 comprises first interstitial region 32 and second interstitial region 34. In the preferred embodiment, first interstitial region 32 and second interstitial region 34 are triangular. As illustrated in FIG. 3B, first interstitial region 32 has a bottom edge that is co-linear with an imaginary line passing through corners 22A and 22D. Preferably, gusset 50 should bisect the imaginary line passing through corners 22A and 22D at its midpoint. The bottom edge of the first side 42 of body region 40 is preferably perpendicular to the bottom edge of interstial region 32. Likewise, the bottom edge of the second side 44 of body region 40 is also preferably perpendicular to the bottom edge of interstial region 34. Sides 38 of interstial region 30 are between vertex 36 and corners 22.

FIG. 3E illustrates gusset 50. Preferably, gusset 50 bisects the imaginary line passing through the corners 22B and 22C at its midpoint and also bisects the imaginary line passing through corners 22A and 22D at its midpoint. Reclosable bag 10 could be used with or without a drawstring unit 60. Typically, drawstring unit 60 would be included when recloseable bag 10 is manufactured. If the drawstring unit 60 is not required, recloseable bag 10 can be manufactured without drawstring unit 60.

Alternatively, drawstring unit 60 could be a pre-formed unit that is heatedly sealed to mouth 46.

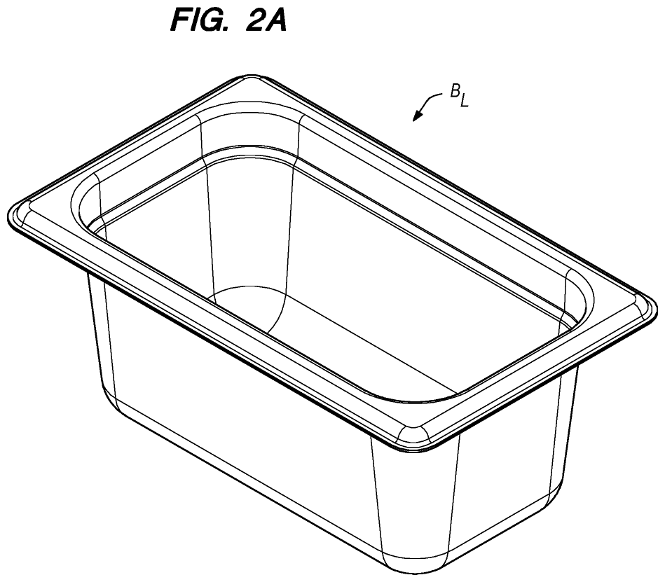

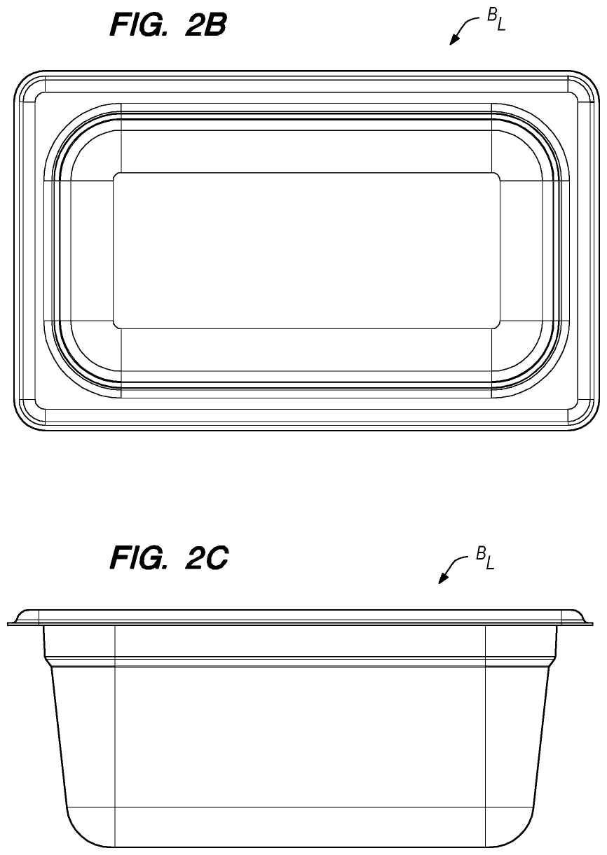

FIG. 4A illustrates a recloseable bag 100 in the opened position. Recloseable bag 100 is typical used in conjunction with the large food storage pan or bin B_{L} illustrated in FIGS. 2A, 2B, and 2C. Recloseable bag 100 comprises a floor region 120, interstitial regions 130, a body region 140, and, in the preferred embodiment, a drawstring unit 160. Recloseable bag 100 may be thought of as the “large bag.” However, this does not mean that a dimension in the “small bag” could not be larger than a dimension of the “large bag,” or visa-versa.

FIGS. 4B and 4C illustrate the recloseable bag 100. FIGS. 4B and 4C also illustrate that floor region 120 is substantially planar and the four corners that are illustrated as 122A, 122B, 122C, and 122D, are substantially in the same plane. Preferably, corners 122A, 122B, 122C, and 122D form a flat surface and planar. As such, Corners A, B, C, and D form a substantially planar surface. The length between each corner may be referred to as an edge of the floor region 120. For example, the section of the floor region 120 between corner 122A and corner 122B may be referred to as one of the edges of floor region 120. For example, the section of the floor region 120 defined by corner 122A and corner 122B may be referred to as one of the edges of floor region 120. Correspondingly, the edge defined by corners 122B-122C, 122C-122D, and 122D-122A may also be referred to as edges of floor region 20.

FIGS. 4A, 4B, 4C, and 4D illustrate the recloseable bag 100. FIGS. 4A, 4B, and 4C illustrate body region 140. Body region 140 has a first side 142, a second side 144, opening 146, and, preferably, a drawstring unit 160. Opening 146 defines the mouth of recloseable bag 100 and also forms an imaginary substantially planar surface that is preferably parallel to the imaginary substantially planar surface formed by corners 122A, 122B, 122C, and 122D. Phrased differently, preferably, both the plane of the imaginary surface defined by the mouth of opening 146 and plane of the surface formed by corners 122A, 122B, 122C, and 122D are parallel to each other. FIGS. 4B and 4C illustrate drawstring unit 160. In a preferred embodiment, drawstring unit 160 allows a user to close opening 146 of recloseable bag 100. Drawstring unit 160 is optional. FIGS. 4A and 4B also illustrates interstitial region 130. Interstitial region 130 comprises first interstitial region 132 and second interstitial region 134. In the preferred embodiment, first interstitial region 132 and second interstitial region 134 are triangular. As illustrated in FIG. 4B, first interstitial region 132 has a bottom edge that is perpendicular to an imaginary line passing through corners 122A and 122D. Preferably, gusset 150 should bisect the imaginary line passing through corners 122A and 122D at its midpoint. The bottom edge of the first side 142 of body region 140 is perpendicular to the bottom edge of interstial region 132. Likewise, the bottom edge of the second side 144 of body region 140 is also perpendicular to the bottom edge of interstial region 134. Sides 138 of interstitial region 130 are between vertex 136 and corners 122.

FIG. 4E illustrates gusset 150. Preferably, gusset 150 bisects the imaginary line passing through the corners 122B and 122C at its midpoint and also bisects the imaginary line passing through corners 122A and 122D at its midpoint. Recloseable bag 100 could be used with or without a drawstring unit 160. Typically, drawstring unit 160 would be included when recloseable bag 100 is manufactured. If the drawstring unit 160 is not required, recloseable bag 100 can be manufactured without drawstring unit 160.

Alternatively, drawstring unit 160 could be a pre-formed unit that is heatedly sealed to mouth 146.

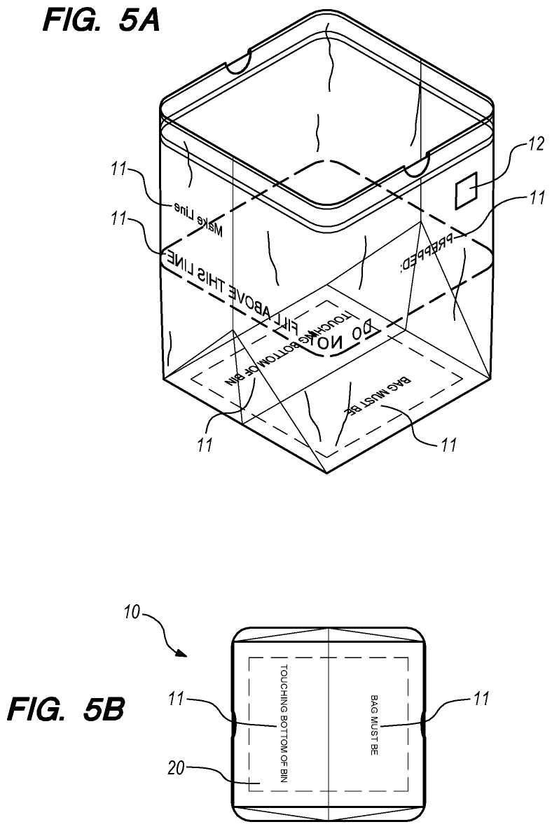

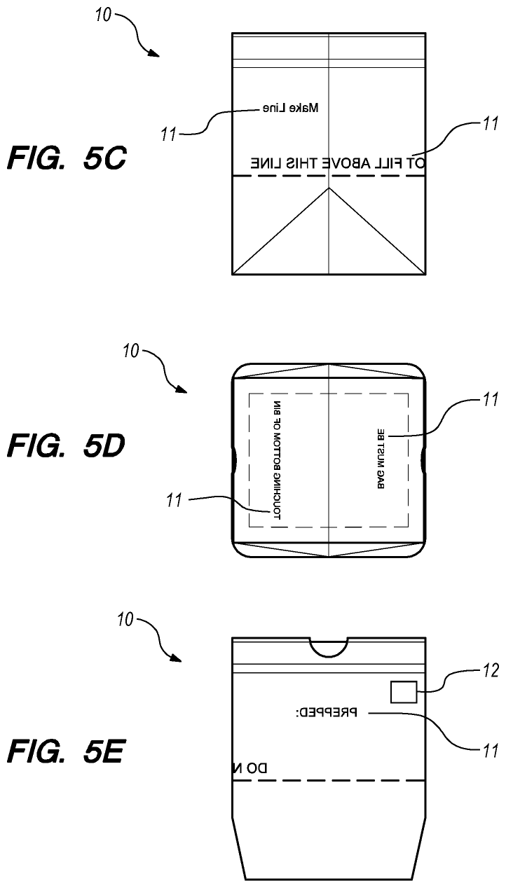

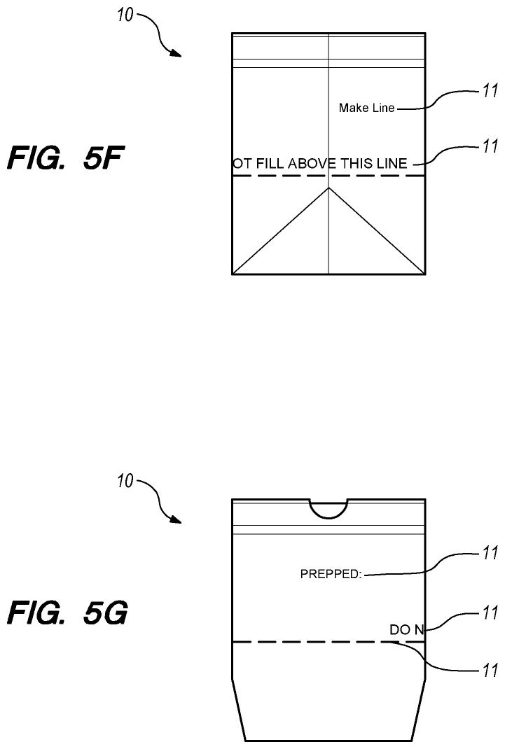

FIGS. 5A, 5B, 5C, 5D, 5E, 5F, and, 5G, illustrate an alternative embodiment of recloseable bag 10 with useful printed information thereon 11. Examples of the useful information could be the date the food was prepared, the date the food should be discarded. Other useful information includes markings to indicate the floor of the bag and the suggested fill line. The fill line is the line above which it is inadvisable to add additional ingredients. In addition, a bar code or sticker representative of useful information 12 could also be used in conjunction with the useful printed information 11. For example, the bar code/sticker 12 might have the expiration date of the food or potential allergens encoded therein. By way of further example, the sticker 12 might depict the food contained in reclosable bag 10. For example, a sticker depicting a unsliced strawberry or unsliced sausage could allow the chef to recognize that sliced strawberry or sliced sausage are contained within reclosable bag 10. FIG. 5A illustrates useful printed information 11 in the form of the phrase “Bag Must Be Touching Bottom of Bin” on the interior surface of floor region 20.

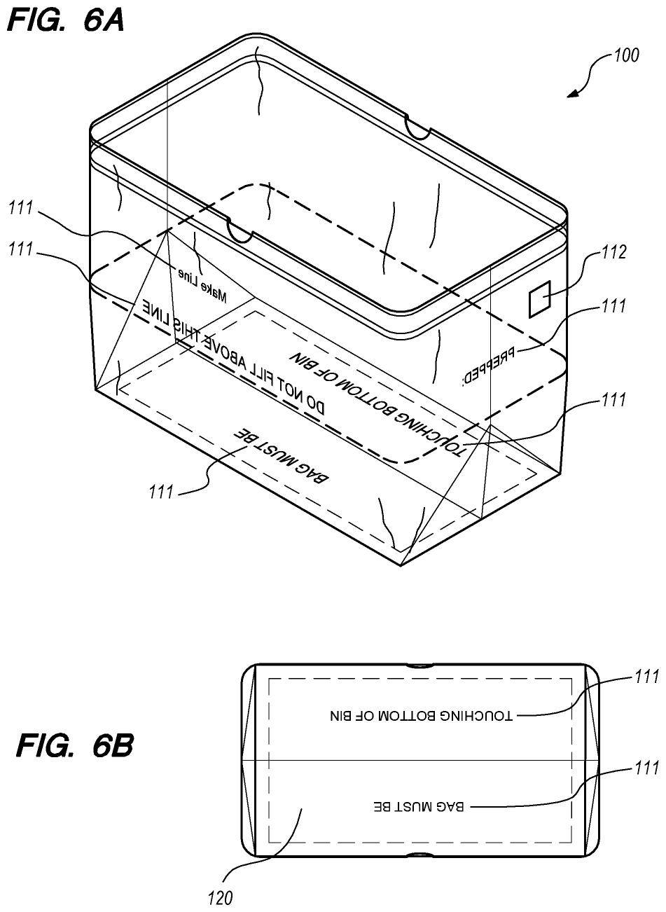

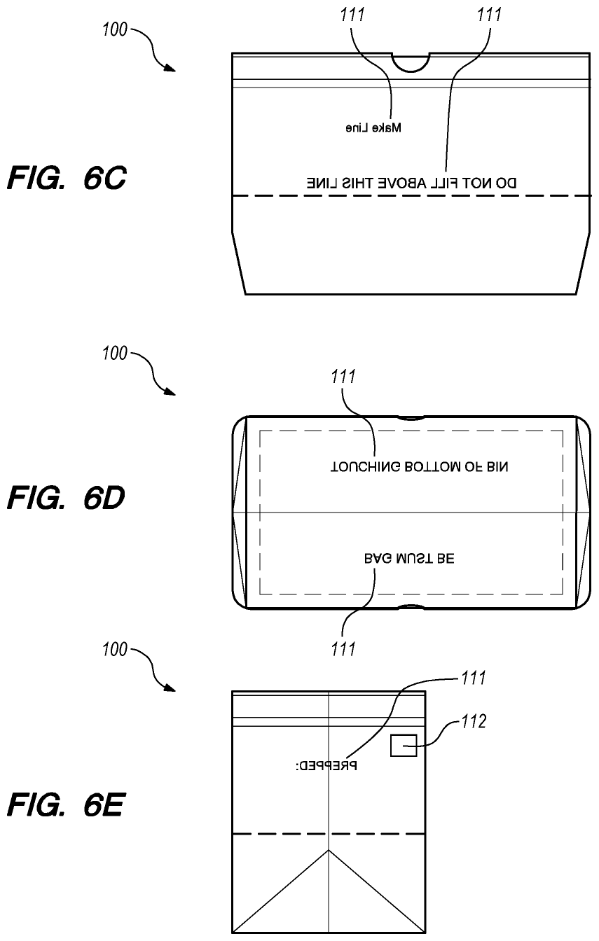

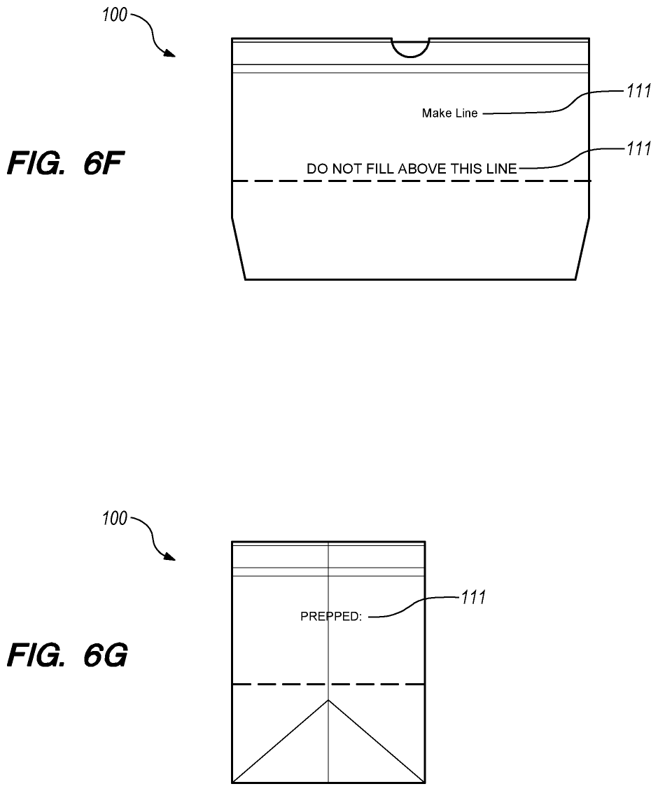

FIGS. 6A, 6B, 6C, 6D, 6E, 6F, and, 6G, illustrate an alternative embodiment of recloseable bag 100 with useful information printed 111 thereon the storage bag 110. Examples of the useful information 111 could be the date the food was prepared, the date the food should be discarded. Other useful information includes markings to indicate the floor of the bag and the suggested fill line. The fill line is the line above which it is inadvisable to add additional ingredients. In addition, a bar code or sticker representative of useful information 112 could also be used in conjunction with the useful printed information 111. For example, the bar code/sticker 112 might have the expiration date of the food or potential allergens encoded therein. By way of further example, the sticker 112 might depict the food contained in reclosable bag 100. For example, a sticker depicting a unsliced strawberry or unsliced sausage could allow the chef to recognize that sliced strawberry or sliced sausage are contained within reclosable bag 100. FIG. 6A illustrates useful printed information 111 in the form of the phrase “Bag Must Be Touching Bottom of Bin” on the interior surface of floor region 120.

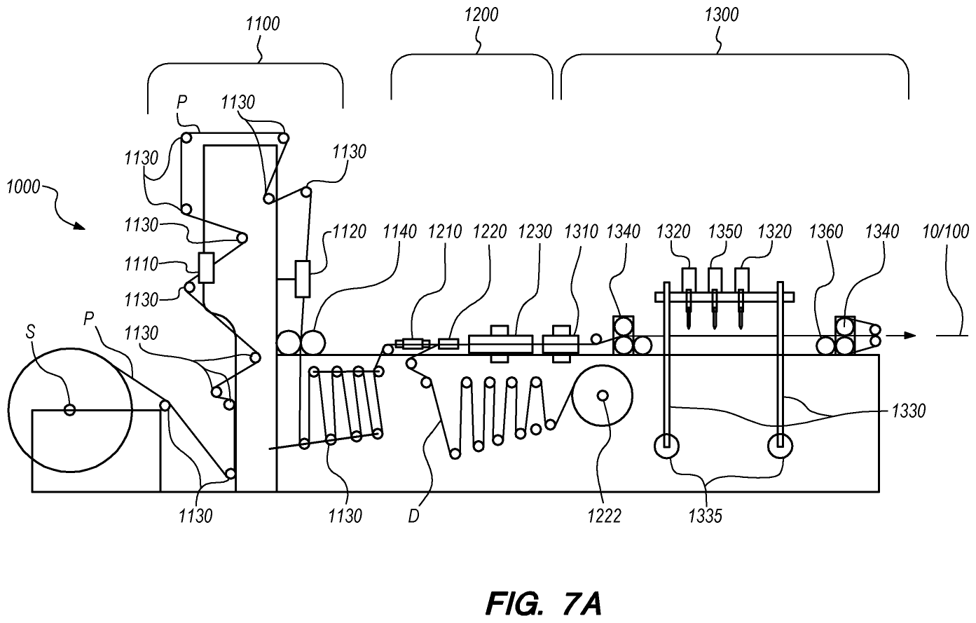

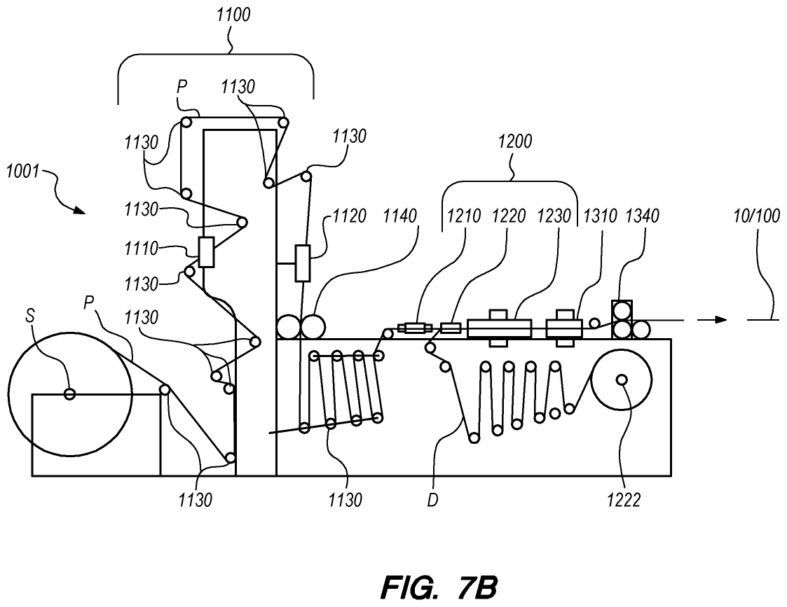

FIG. 7A illustrates a bag machine 1000 used to manufacture storage bags 10/100. Preferably, bag 10/100 is formed of polyethylene or polypropylene plastic. Most preferably, bag 10/100 is formed of LPDE or HPDE plastic and plastic film P is at least one millimeter thick (In imperial units, this is 0.0393701 inches thick.)

FIG. 7A illustrates the preferred bag machine 1000 used to manufacture bags 10/100 from plastic film P. Machine 1000 comprises shaping section 1100, closure section 1200, and, sealing section 1300. In the preferred embodiment, each section has a motorized feeder roller that is synchronous with the motorized feeder rollers of the other sections. Preferably, and phrased differently, film P is advanced through shaping section 1100, closure section 1200, and, sealing section 1300 with a synchronous motorized feeder roller for each section.

FIG. 7A further illustrates that shaping section 1100 comprises reclosable opening formation mechanism 1110, gusset wheel mechanism 1120, tension roller 1130, and, feeder rollers 1140.

FIG. 7A further illustrates spool S, illustrated at the left side of FIG. 7A. Spool S is preferably an extruded plastic film which is, preferably, one millimeter (0.0393701 inches) of thick plastic film P wound onto spool S. Typically, spool S is a thousand foot (304.8 meter) side-folded sheet of plastic film P. FIG. 8A illustrates side-folded plastic film P. The side-folded edge is S_{Folded} and the open edge is S_{Open}. Tension rollers 1130 control feeding tension of plastic film P as in process bag 10/100 is manufactured by machine 1000. As plastic film P unwinds from spool S, reclosable opening folding mechanism 1110 and gusset folding mechanism 1120 shape plastic film P such that a flap F is formed on the open edge S_{Open} of in process bag 10/100 and a gusset 50 is formed in S_{folded}. (As used in this application, “in process bag,” refers to a bag 10/100 that is in the process of being manufactured, not a finished bag.) In other words, reclosable opening formation mechanism 1110 places a gusset 50 on opposite side of in process bag 10/110, otherwise referred to as the side-folded edge S_{Folded} of plastic film P. FIG. 8B illustrates formation of the flap F and FIG. 8C illustrates the formation of gusset 50. Preferably, gusset formation and flap formation occur contemporaneously. However, these operations could occur in series or parallel and no particular sequence of the operations is required. Phrased differently, the gusset 50 and the flap F may be formed in any order or concurrently. FIG. 7A also illustrates that tension rollers 1130 and feeder rollers 1140 control plastic film P as it is formed into bag 10/100. Preferably, feeder rollers 1140 are motorized. Feeder rollers 1140 may be fixed or variable rollers, or a combination of fixed and variable rollers. Preferably, three synchronous motorized feeder rollers advance film P. Preferably, film P is advanced through shaping section 1100, closure section 1200, and, sealing section 1300 with a separate motorized feeder roller for each section. Feeder rollers 1140, and the other feeder rollers used throughout machine 1000, may be thought of as “pulling” or “propelling” or “moving” plastic film P through machine 1000.

As illustrated in FIGS. 7A and 8B, reclosable opening formation mechanism 1110 folds a flap F, along an edge of plastic film P. Gusset mechanism 1120 forms gusset 50, in plastic film P, as illustrated in FIGS. 7A and 8C. As illustrated in FIG. 7A, feeder rollers 1140 and tension rollers 1130, move in process bag 10/110 through closure section 1200 of machine 1000. In a preferred embodiment, tension rollers 1130 may be tension spools, (tension spools having a smaller diameter than a tension roller, but tensioning plastic film P in the same manner as tension rollers 1130). FIGS. 7A and 8D illustrate hole punch 1210 punches a hole H therethrough flap F, as illustrated in FIGS. 7A and 8D. FIGS. 7A and 8E and 8F illustrate drawtape threader 1220 threads drawtape D therethrough flap F. Before threading through flap F, drawtape D is spooled on drawtape spool 1222. FIGS. 7A and 8F illustrate flap sealer 1230 seals flap F and drawtape D is slidably retained within a channel C of flap F. Preferably, drawtape channel sealer 1230 is a heated bar press that heats the bottom edge of the flap F to heatingly flap F such that drawtape D is retained therein. Preferably, drawtape channel sealer 1230 is heated to 300-399 degrees Centigrade (572-750 degrees Fahrenheit). FIG. 8G illustrates the location of the heat sealing of in process bag 10/100 with dashed lines. The dashed lines are not actually present on bag 10/100. Rather, the dashed lines represent the use of draw tape channel sealer to “heat seal” the bottom edge of flap F such that drawstring D is sealingly contained therein.

FIG. 7A also illustrates heating section 1300. Heating section 1300 comprises a side sealer 1310, flat bottom sealer 1320, guide bars 1330, guide bar drive wheels 1335, feeder rollers 1340, and, material press 1350. Preferably, a silicon mat 1360 and material press 1350 hold in process bag 10/110 as flat bottom sealer 1320 of heating section 1300 operates.

Side sealer 1310 heat seal S_{leading} and S_{trailing} of body region 40. Preferably, side sealer 1310 is heated to 300-399 degrees Centigrade (572-750 degrees Fahrenheit). FIGS. 8A, 8G, 8H, and 8I illustrate that the edges S_{leading} and S_{trailing} are also sealed. S_{leading} refers to the side of plastic film P that enters machine 1000 slightly before S_{trailing}. In a very rough analogy, S_{leading} might be thought of as the front of a parade or a railway engine and S_{trailing} might be thought of as the caboose of the train or the end of the parade.

FIGS. 7A, 8H, and 8I illustrates flat bottom sealer 1320 removing angled sections A of in process bag 10/100 and also sealing these seams. Angled sections A may be discarded. FIGS. 3C and 5C illustrate that gusset 50 bisects the longitudinal dimension of floor region 20. Flat bottom sealer 1320 seals edges 22A-22D and 22B-22C of in process bag 10/100. For in process bag 10/100, flat bottom sealer 1320 seals edges 122A-122D and 122B-122C. Preferably, side sealer 1310 is heated to 300-399 degrees Centigrade (572-750 degrees Fahrenheit). As above, the dashed lines are not actually present on bag 10/100. Rather, the dashed lines graphically represent the seam that is sealed.

FIG. 7A illustrates that feeder roller 1340 (seen to the right of flat bottom sealer 1320) ejects bag 10/100 from machine 1000. FIGS. 7A and 8I illustrates that finished bag 10/100 are ejected from machine 1000. Bags 10/100 may fall into a box (not shown) or be collected on a pallet (not shown) for shipment.

FIG. 7B illustrates a part of a partially automated and partially manual process for manufacturing the storage bag 1001. More specifically, FIG. 7B illustrates a partially formed storage bag 10/100 in which only a portion of the manufacturing process is automated. Still more specifically, the work performed by flat bottom sealer is performed manually when partially automated machine 1001 is employed. Thus, the part of the process illustrated at FIGS. 8H and 8I are performed manually. Phrased differently, bag machine 1001 uses the same automated processes as preferred bag machine 1000 illustrated in FIGS. 8A-8G. However, after the bag machine 1001's process reaches the step illustrated in FIG. 8G, the steps illustrated in FIGS. 8H and 8I are performed manually. By way of example, and not limitation, angled sections A could be removed and the edges of the bag sealed in series or concurrently. Indeed, a heated bar or knife edge could be used to remove angled sections A and the edges sealed using a heated surface. By way of example and not limitation, a bar sealer could be used for this sealing.

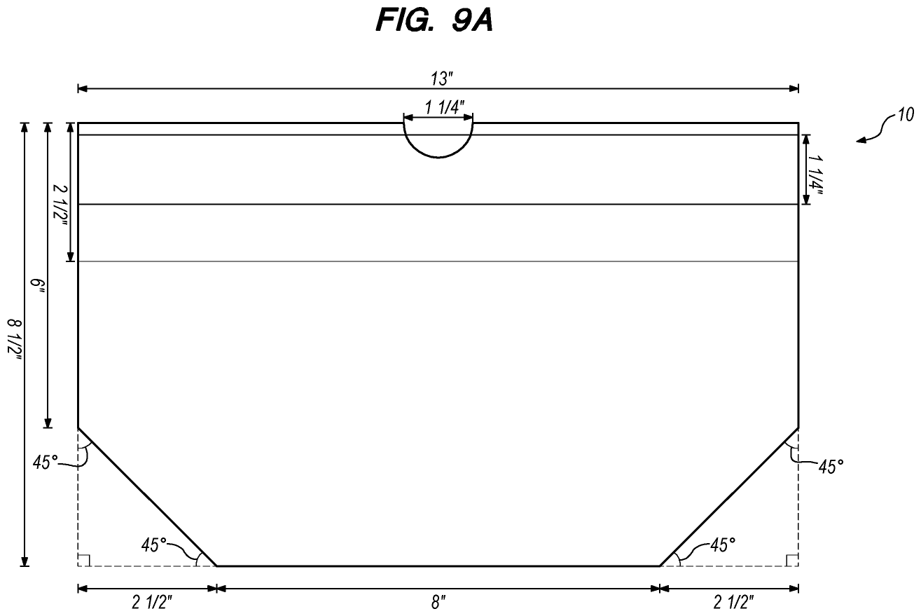

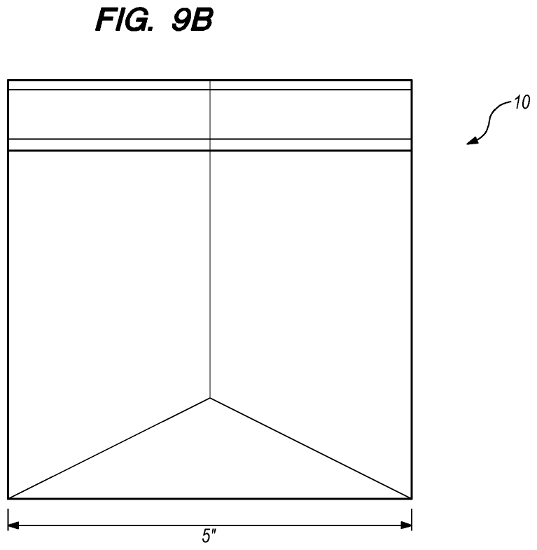

FIGS. 9A and 9B illustrate the preferred dimensions of storage bag 10.

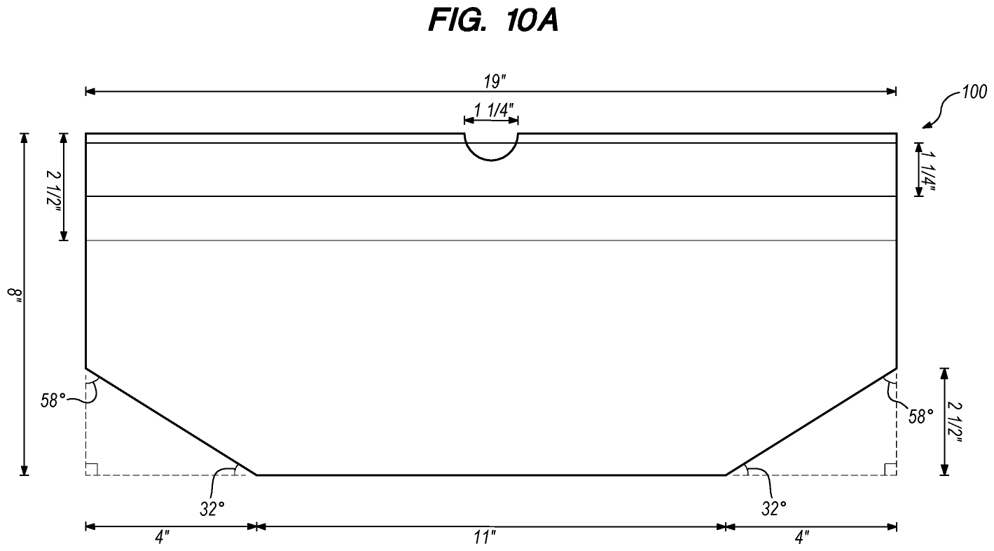

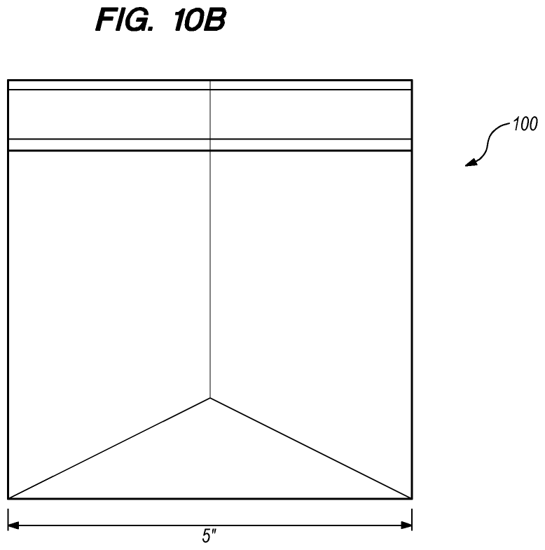

FIGS. 10A and 10B illustrate the preferred dimensions of storage bag 110.

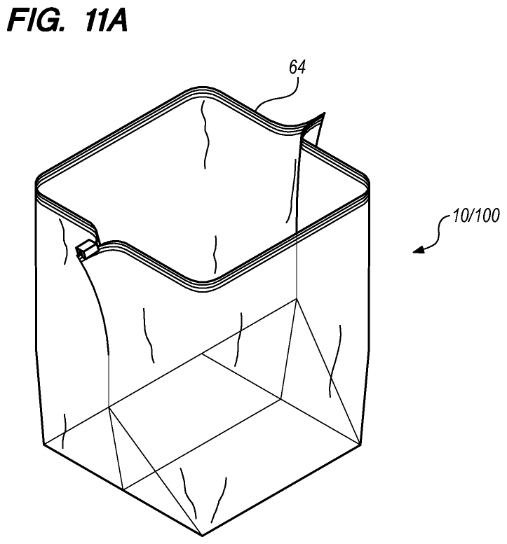

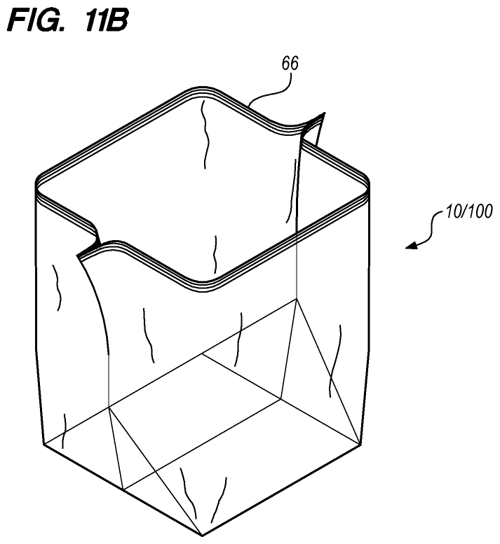

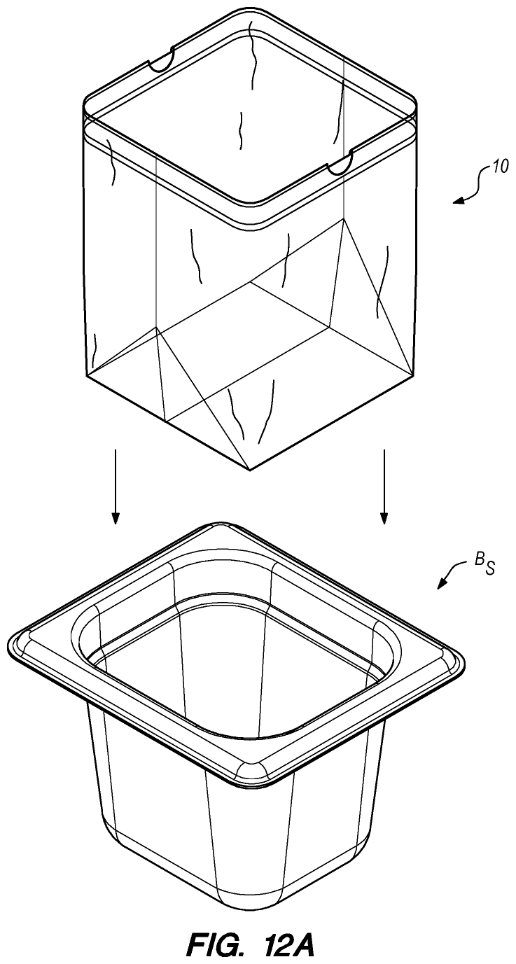

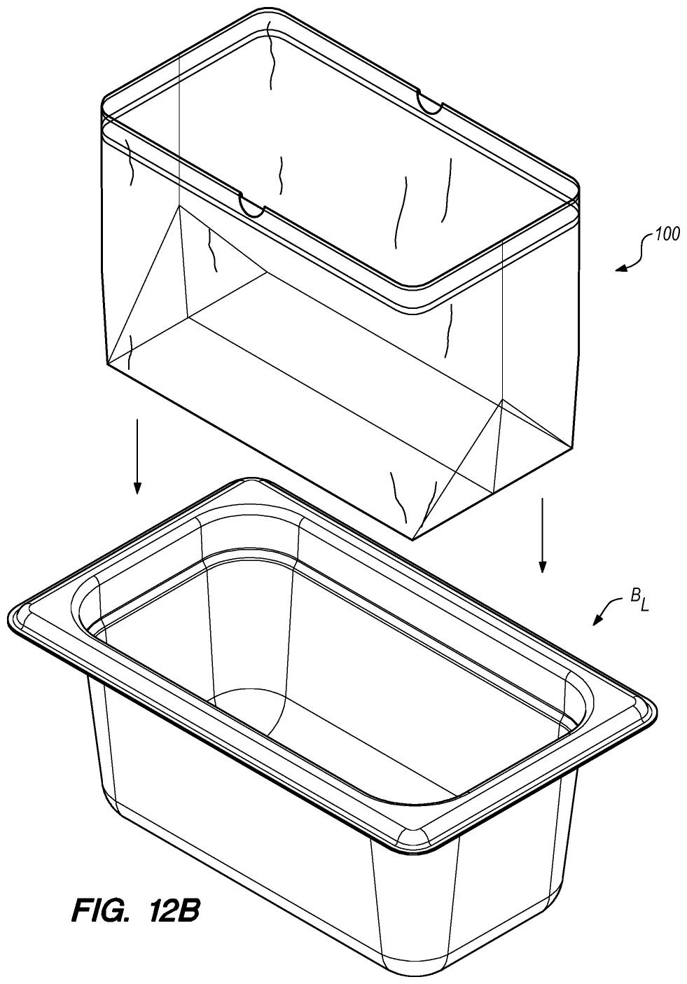

FIG. 11A illustrates a perspective view of an alternative closure mechanism comprising a slide lock closure 64 for recloseably closing the storage bag 10/100. Phrased differently, slide lock closure 64 is an alternative to drawstring unit 60.

FIG. 11B illustrates a perspective view of an alternative closure mechanism comprising a press lock closure 66 for recloseably closing the storage bag 10/100. Phrased differently, press lock closure 66 is an alternative to drawstring unit 60.

FIG. 12A illustrates a perspective view of the embodiment illustrated in FIGS. 3A-3E in conjunction with the typical prior art small food storage pan or bin B_{S} illustrated in FIGS. 1A-1C. More specifically, FIG. 12A illustrates storage bag 10 use with small bin B_{S}.

FIG. 12B illustrates a perspective view of the embodiment illustrated in FIGS. 4A-4E in conjunction with the typical prior art small food storage pan or bin B_{L} illustrated in FIGS. 2A-2C. More specifically, FIG. 12B illustrates storage bag 100 use with larger bin B_{L}.

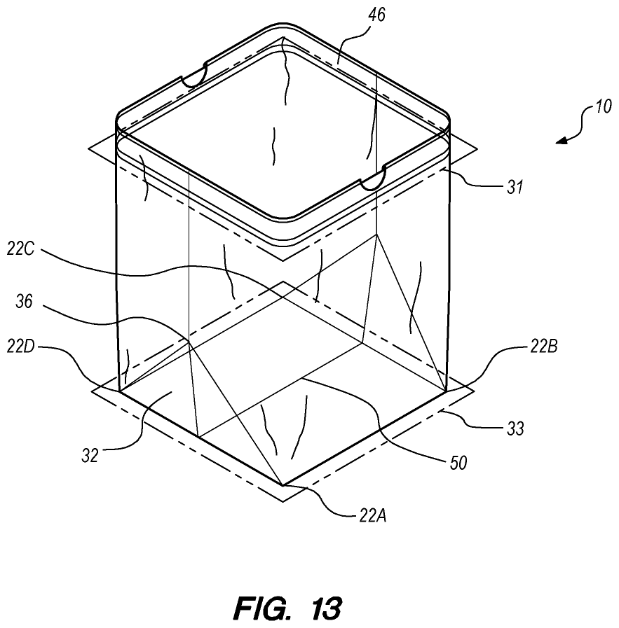

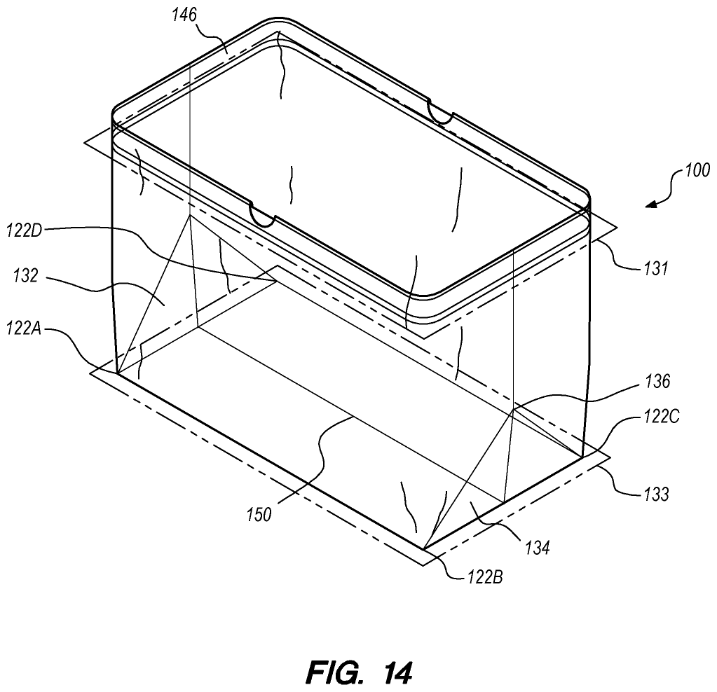

FIG. 13 illustrates a perspective view of the storage bag 10 illustrated in FIG. 3A and further illustrates imaginary planar surface 31 of the mouth 46 of storage bag 10 and the corners 22A, 22B, 22C, and 22D of the floor region 20 of the storage bag 10 that coincide with imaginary plane 33. FIG. 13 further illustrates that the two imaginary planes are substantially parallel.

FIG. 14 illustrates a perspective view of the larger embodiment of the storage bag 100 illustrated in FIG. 4A and further illustrates imaginary planar surface 131 of the mouth 146 of larger embodiment of the storage bag 100 and the corners 122A, 122B, 122C, and 122D of the floor region of the storage bag 100 that coincide with imaginary plane 131. FIG. 14 further illustrates that the two imaginary planes are substantially parallel.

While the invention has been illustrated and described in detail in the drawings and description, the same is to be considered as an illustration and is not limited to the exact embodiments shown and described. All equivalents, changes and modifications that come within the spirit of the invention are also protected by the claims that are set forth below.

What I claimed is:

1. A storage bag, comprising:
a planar floor region, the floor region having at least four corners and four edges, the four corners defining a planar surface;
a pair of opposing triangular interstitial regions, each triangular interstitial region having a vertex, two sides, and a base, each of the two sides extending from the vertex to one corner of the floor region, the base of the triangle co-linear with one edge of the floor region;
a gusset, the gusset bisecting the floor region and both opposing interstitial regions, the gusset co-linear with the vertex of both of the triangular interstitial regions;
a pair of opposing body regions, the lower edge of each opposing body region co-linear with two corners of the floor region; and,
an opening, the corners of the opening forming an imaginary plane, wherein the planar surface formed by the corners of the floor region and the imaginary plane formed by the opening of the body region are in parallel planes after the storage bag is opened for use.

2. The storage bag of claim 1, further comprising: a flap coincident with the opening of the storage bag, the flap further comprising a draw tape suitable for closing the opening of the storage bag.

3. The storage bag of claim 2, wherein the storage bag is formed from a plastic film.

4. The storage bag of claim 3, wherein the plastic film has a thickness of 0.5 millimeters to 10 millimeters.

5. The storage bag of claim 4, wherein the plastic film has a thickness of 1.0 millimeter.

6. The storage bag of claim 3, wherein the planar floor region is a rectangle.

7. The storage bag of claim 3, wherein the planar floor region is a square.

8. The storage bag of claim 1, wherein the area of the planar surface formed by the corners of the floor region is less than the area of the imaginary plane formed by the opening of the body region after the storage bag is opened for use.

9. The storage bag of claim 1, wherein the interstial spaces are angled outwardly.

10. The storage bag of claim 1, wherein the outward angle of the interstitial region is more than 5 degrees.

11. The storage bag of claim 1, further comprising: each triangular interstitial region is an isosceles triangle.

12. A method of forming a storage bag from a side-folded sheet of plastic film, the side-folded sheet comprising an open side, a folded side, a leading side and a trailing side, comprising:
(a) forming a flap on the open side of the plastic film;
(b) forming a gusset on the closed side of the plastic film;
(c) punching a hole therethrough the flap;
(d) threading a draw tape therethrough the flap;
(e) heatedly sealing the leading side of the plastic film;
(f) heatedly sealing the trailing side of the plastic film;
(g) heatedly sealing the flap, thereby retaining the draw tape within a channel formed therein the flap;
(h) removing opposing triangular portions of the plastic film;
(i) heatedly sealing the edges of the plastic film from which the opposing triangular portions of the plastic film were removed.

13. The method forming the storage bag from a side-folded sheet of plastic film of claim 12, further comprising: advancing the two side-folded sheet of plastic film using a motorized feeder roller.

14. The method of forming the storage bag from a side-folded sheet of plastic film of claim 13, further comprising: forming the flap and forming the gusset occur in series.

15. The method of forming the storage bag from a side-folded sheet of plastic film of claim 13, further comprising: forming the flap and forming the gusset occur in parallel.

16. The method forming the storage bag from a side-folded sheet of plastic film of claim 12, further comprising: selecting the dimensions of the storage bag such that the storage bag is taller than the interior height of a food storage bin.

17. The method forming the storage bag from a side-folded sheet of plastic film of claim 12 further comprising: heatingly sealing the storage bag employing a heated bar.

18. The method of forming the storage bag from a side-folded sheet of plastic film of claim 17, further comprising: the temperature of the heating bar during sealing is selected from the range of 300-399 degrees (Centigrade (572-750 degrees Fahrenheit).

19. A method of forming a storage bag from a side-folded sheet of plastic film, the side-folded sheet comprising an open side, a folded side, a leading side and a trailing side, comprising:
(a) forming a gusset on the closed side of the plastic film;
(b) heatedly sealing the leading side of the plastic film;
(c) heatedly sealing the trailing side of the plastic film;
(d) removing opposing triangular portions of the plastic film;
(e) heatedly sealing the edges of the plastic film from which the opposing triangular portions of the plastic film were removed;
(f) heatingly sealing a closure mechanism to the open side of the storage bag.

20. The method of forming a storage bag from a side-folded sheet of plastic film of claim 19, further comprising: selecting the closure mechanism from the group consisting of a slide lock closure and a press lock closure.
